(19) United States
(12) Patent Application Publication
(10) Pub. No.: US 2007/0131764 A1
(43) Pub. Date: Jun. 14, 2007

(54) Product display arrangement and system

(76) Inventor: Patrick Wallace, San Jose, CA (US)

Correspondence Address: FAY KAPLUN & MARCIN, LLP, 15O BROADWAY, SUITE 702, NEW YORK, NY, 10038, US

(21) Appl. No.: 11/299,984

(22) Filed: Dec. 12, 2005

(51) Int. Cl. G06K 15/00; G06K 19/06

(52) U.S. Cl. 235/383; 235/492

(57) ABSTRACT

Described are is a wireless device for outputting product-related data comprising a memory, an output arrangement, a wireless receiver and processor. The memory stores first product-related data. The output arrangement outputs the first product-related data. The wireless receiver receives a wireless signal including second product-related data. When the wireless receiver receives the wireless signal, the processor processes the second product-related data to replace the first product-related data so that the output arrangement outputs the second product-related data. The device is situated adjacent to a product. The first product-related data corresponds to the product and the second product-related data corresponds to one of the product and a further product.

### FIELD OF INVENTION

The present invention generally relates to a product display arrangement and a system implementing the same.

### BACKGROUND INFORMATION

Within retail stores, warehouses and grocery stores, products are displayed on shelves and/or bins. Formerly, the products were individually labeled for sale by an employee applying a price tag to each item. Currently, the price tag is disposed on the shelves adjacent to a location of the item. Shelf-labeling eliminated the time and cost of marking each product. However, when a price change is necessitated, a current price tag is removed, and a new price tag is printed and affixed to the shelf. Manually adjusting and/or replacing the price tags for each of the products in the store may require several employees working over several hours. Thus, there is a need for a more efficient manner of displaying product information.

### SUMMARY OF THE INVENTION

The present invention relates to a product display arrangement and system. The product display arrangement includes a wireless device for outputting product-related data comprising a memory, an output arrangement, a wireless receiver and processor. The memory stores first product-related data. The output arrangement outputs the first product-related data. The wireless receiver receives a wireless signal including second product-related data. When the wireless receiver receives the wireless signal, the processor processes the second product-related data to replace the first product-related data so that the output arrangement outputs the second product-related data. The device is situated adjacent to a product. The first product-related data corresponds to the product and the second product-related data corresponds to one of the product and a further product.

### BRIEF DESCRIPTION OF DRAWINGS

FIG. 1 shows an exemplary embodiment of a system according to the present invention;

FIG. 2 shows an exemplary embodiment of a product display arrangement according to the present invention;

FIG. 3 shows an exemplary embodiment of a method according to the present invention; and

FIG. 4 shows an exemplary embodiment of a table including product data according to the present invention.

### DETAILED DESCRIPTION

The present invention may be further understood with reference to the following description and the appended drawings, wherein like elements are provided with the same reference numerals. The present invention describes a product display arrangement and a system implementing the same. The exemplary embodiment of the arrangement will be described as being implemented in a retail store. However, those of skill in the art will understand that the present invention may be utilized in any venue in which items are displayed along with information related to each item, such as, for example, a grocery store, a warehouse, a library, etc.

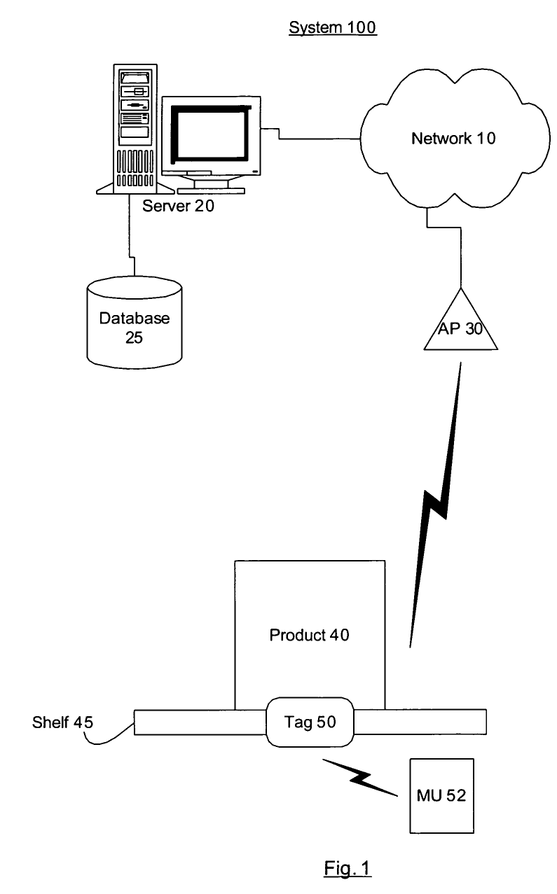

FIG. 1 shows an exemplary embodiment of a system 100 according to the present invention. The system 100 includes a communications network 10 (e.g., a wired/wireless LAN, WAN or the Internet) having at least one access point/port (“AP”), such as an AP 30, providing access thereto. The system 100 may further include a server 20 including or coupled to a database 25 and having access to the network 10. When the system 100 is deployed within a retail store, the database 25 may include product identifiers and corresponding product data, as will be described further below. Within the store, products (e.g., a product 40) are arranged on display arrangements (e.g., a shelf 45, a bin, a promotional marketing display, etc.).

According to the present invention, a product display arrangement (e.g., an electronic price tag 50) is coupled to the shelf 45 in a location corresponding to a location of the product 40. The tag 50 displays product data (e.g., price, discount, rebate, coupon, quantity, identifier, etc.). As will be described further below, the product data may be remotely updated using the server 20 or manually updated by a store employee using a wireless computing device. Additionally, the tag 50 may be relocated and reconfigured to display new product data corresponding an update of the product data and/or a different product. A store employee or customer may transfer and/or obtain the product data from the tag 50 using the wireless computing device (e.g., a mobile unit (MU) 52) including, but not limited to, a phone, a PDA, a laser/image-based scanner, an RFID reader, a network interface card, a laptop, etc.

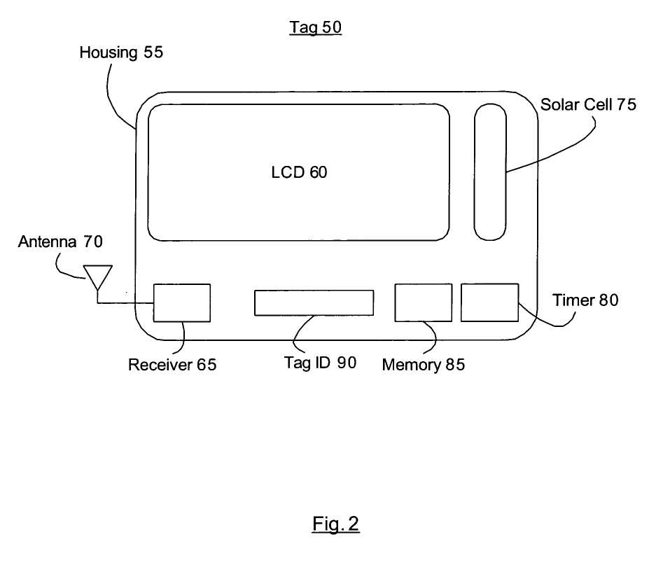

An exemplary embodiment of the tag 50 is shown in FIG. 2. Components of the tag 50 may be encased within a housing 55 which is preferably made of a durable and lightweight material (e.g., plastic, ceramic, composite materials, etc.). The housing 55 may be colored, sized and/or shaped based on identifiers (e.g., logo, colors, trademarks) of the retail store. In other embodiments, a manufacturer of the product 40 may provide the retail store with the tag 50 so that the color, size, shape, etc. of the housing 55 are indicative of the product 40 and/or the manufacturer. At least a portion of the housing 55 includes a coupling mechanism for attaching the tag 50 to the shelf 45. The coupling mechanism may include, but is not limited to, a magnet, an adhesive, Velcro®, a clip, etc. Those of skill in the art will understand that the coupling mechanism may provide for temporary or permanent attachment of the tag 50 to the shelf 45.

The tag 50 further includes an output arrangement which may include a display (e.g., an LCD 60) which displays the product data to the customer, a speaker, an LED and/or a Braille device. In a preferred embodiment, the LCD 60 is a thin-film, multi-lined LCD. As stated above, the product data may include text and/or graphics which are indicative of the price, quantity, coupons, rebates, discounts, etc. The product data may further include an image of a product identifier (e.g., a bar code). A store employee may scan the product identifier to confirm the product data, and a customer may scan the product identifier to retrieve additional product information stored in the database 25 and/or add the product 40 to a shopping list (e.g., an electronic shopping list).

The tag 50 utilizes a wireless communication arrangement (e.g., a receiver 65, a transceiver) to receive radio frequency (RF) signals transmitted from the AP 30, the MU 52 or any other device configured to transmit signals according to a predetermined wireless protocol (e.g., IEEE 802.11x protocol). Preferably, the receiver 65 is a low-power receiver, because its receiving range need only extend through a predetermined area of the retail store which includes at least one AP. An antenna element 70 may be coupled to the receiver 65 facilitating the reception of the RF signals. In one embodiment, the receiver 65 is operated in conjunction with a timer 80 which instructs the receiver 65 to power-on at one or more predefined times, as will be described further below.

A power supply (e.g., a solar cell 75, a battery, line voltage, a transient electrical storage) is embedded in and/or coupled to the tag 50. For example, the solar cell 75 may be positioned on a face of the tag 50 which allowing it to receive ambient light (e.g., store lighting, natural light). The solar cell 75 may utilize normal store lighting to power the tag 50, and, optionally, charge a capacitor (not shown) which may aid in booting the receiver 65. The tag 50 further includes a memory 85 (e.g., a non-volatile memory) storing the product data, an identifier (e.g., a serial number, an IP/MAC address, etc.). In the exemplary embodiment, the tag 50 includes a tag identifier (ID) 90 (e.g., a bar code) which uniquely identifies the tag 50. A store employee may scan the tag ID 90 when, for example, reporting a malfunction of the tag 50 (e.g., LCD damage, non-responsive to wireless transmissions, etc.). A malfunction report may then be wirelessly transmitted from the MU 52 to the server 20.

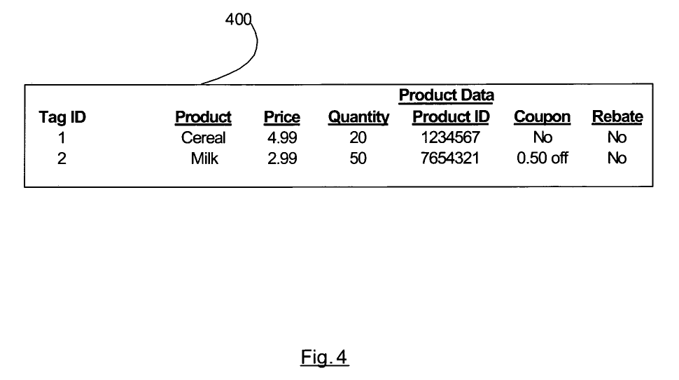

Prior to being deployed within the store, the tag 50 may be initialized and configured with the product data corresponding to the product 40. In one embodiment, the tag 50 is configured by the server 20. For example, the server 20 may store the tag ID 90 and the corresponding product data in a table 400, as shown in FIG. 4. The server 20 transfers the product data (or select portions thereof) to the tag 50, which may then be deployed in the store. In another embodiment, the tag 50 may be configured by the MU 52. The MU 52 may scan the product identifier and the tag ID 90 generating a data request which is transmitted to the server 20. The server 20 queries the database 25 as a function of the product identifier to retrieve the corresponding product data. The server 20 may then transmit the product data to the tag 50 and/or the MU 52. Those of skill in the art will understand that tag 50 may be configured by any computing device with access to the network 10 (e.g., a retail store headquarters server). The device may retrieve the product data from the database 25 or a further database accessible on the network 10, and transmit the product data to the tag 50.

When the tag 50 is deployed in the store, the LCD 60 may display the product data corresponding to the product 40. The product data is stored in the memory 85 of the tag 50. Several conditions may require the product data to be updated and/or changed. For example, the store (or chain of stores) may have a sale for the product 40, or costs associated with the product 40 may fluctuate, as is the case with, for example, orange juice, fruits and vegetables, etc. Alternatively, the tag 50 may be relocated within the store and used to display the new product data corresponding to a different product.

The tag 50 may download the new product data (e.g., updated product data or different product data) at a predefined time. Preferably, the server 20 initiates the update of the product data during off-hours (e.g., while the store is closed). The update may occur each night and/or only when the product data for the tag 50 is being updated/changed. Those of skill in the art will understand that when the tag 50 does not include a transmitter (i.e., only the receiver 65) the new product data may be transmitted a predetermined number of times over a predetermined time period to ensure that it is received by the tag 50. That is, without a transmitter, the tag 50 may not be capable of acknowledging receipt of the new product data.

In another exemplary embodiment, the product data may be updated by a store employee using the MU 52 to transmit the new product data to the tag 50. The MU 52 may download the new product data from the server 20. To transmit the new product data to the tag 50, the MU 52 may scan the tag ID 90 to identify the tag 50, and transmit the new product data to the tag 50. Transmission from the MU 52 to the tag 50 may be useful when, for example, there is a problem with the server 20.

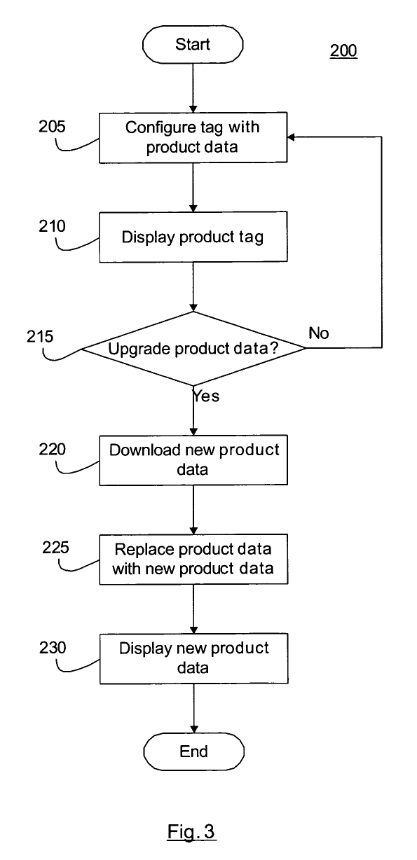

FIG. 3 shows an exemplary embodiment of a method 200 according to the present invention. In step 205, the tag 50 is configured with the product data corresponding to the product 40. As noted above, the product data may be transferred to the memory 85 of the tag 50 from the server 20, the MU 52 or any other computing device with access to the network 10. In step 210, the tag 50 displays the product data on the LCD 60. The product data may include static and/or dynamic images. For example, during the store's operating hours, the price of the product 40 may be displayed as a static image. However, coupons, rebates, discounts, upsell product offers (e.g., products that when purchase with the product 40 entitle the customer to a discount on one or both products), etc. may be displayed as a series of dynamic images. The LCD 60 may be controlled by the timer 80 to power on/off as a function of the store's operating hours (e.g., on at opening, off at closing).

In step 215, it is determined whether the product data requires an update (e.g., a sale on the product 40) or change (e.g., the tag 50 is associated with a different product). In either instance, the product data in the memory 85 and currently displayed by the tag 50 may be replaced by the new product data. In the exemplary embodiment, the new product data is entered manually at the server 20 and/or retrieved from the database 25. For example, the system 100 may be time-based, such that, at a predetermined interval (e.g., overnight) the server 20 determines whether the new product data is available. That is, the new product data may be downloaded from a headquarters server (not shown) to the database 25 at a time prior to when the server 20 queries the database 25. The product data may be changed when, for example, the price of the product requires adjustment, the tag 50 is associated with a different product or function, the tag 50 is moved to a different location in the store, etc. According to the present invention, the product data may be updated via the server 20, the MU 52, a central server accessing the tag 50 over the network 10 or any other computing device capable of transmitting radio frequency signals to the tag 50. When the product data does not require the update/change, the tag 50 maintains the display of the product data.

In step 220, the tag 50 downloads the new product data. The server 20 may transmit only the new product data corresponding to the product 40, or the table 400 may be broadcast by the AP 30. In one exemplary embodiment, the receiver 65 may be powered by the timer 80. For example, the timer 80 may instruct the receiver 65 to power-on at the predefined time, e.g., when the new product data will be transmitted. Preferably, this occurs after the store has closed. In another exemplary embodiment, the receiver 65 of the tag 50 is continually powered. In this embodiment, the new product data may be transmitted to the tag 50 at any time. This may be advantageous when, for example, the tag 50 is relocated and associated with a different product.

Control of the timer 80 may be overridden manually or remotely. For example, during the store's operating hours, an employee may be required to alter the product data. The employee may reset the tag 50 or activate the receiver 65 in any other manner. For a remote override, the server 20 may instruct the tag 50 to change the predefined time/duration and/or keep the receiver 65 powered continually. This instruction may be transmitted along with the new product data.

In step 220, the product data is replaced with the new product data. The memory 85 may store the product data and/or the new product data based on a storage capacity thereof. When the table 400 is broadcast, the tag 50 replaces a previous table with the table 400 and displays the new product data corresponding to its tag ID 90.

In step 225, the tag 50 displays the new product data on the LCD 60. In the exemplary embodiment, the LCD 60 only displays the new product data after receipt thereof. However, in another embodiment, a display instruction may be included with the new product data. The instruction may indicate that the new product data should not be displayed until a preselected time (e.g., the day a sale begins).

According to the present invention, the product data may be updated remotely without knowing a location of the tag 50 in the store. Also, the tag 50 may be reconfigured which lowers costs associated with disposable electronic tags.

One skilled in the art would understand that the present invention may also be successfully implemented in various other embodiments. Accordingly, various modifications and changes may be made to the embodiments without departing from the broadest spirit and scope of the present invention as set forth in the claims that follow. The specification and drawings are accordingly to be regarded in an illustrative rather than restrictive sense.

What is claimed is:

1. A wireless device for outputting product-related data, comprising:
a memory storing first product-related data;
an output arrangement outputting the first product-related data;
a wireless receiver receiving a wireless signal including second product-related data; and
a processor,
wherein, when the wireless receiver receives the wireless signal, the processor processes the second product-related data to replace the first product-related data so that the output arrangement outputs the second product-related data,
wherein the device is situated adjacent to a product,
wherein, the first product-related data corresponds to the product and the second product-related data corresponds to one of the product and a further product.

2. The device of claim 1, further comprising:
a power supply.

3. The device of claim 2, wherein the power supply is one of a solar cell, a battery and a transient electrical storage.

4. The device of claim 2, further comprising:
a timer controlling operation of the receiver, the timer instructing the receiver to power-on at a first time and power-off at a second time.

5. The device of claim 1, wherein the memory is a non-volatile memory.

6. The device of claim 1, wherein the output arrangement includes one of a display, an LED and a speaker.

7. The device of claim 1, wherein the first product-related data includes at least one of a first price, a first quantity, a first product identifier, a first coupon, a first rebate and a first discount corresponding to the product.

8. The device of claim 7, wherein the second product-related data includes at least one of a second price, a second quantity, a second product identifier, a second coupon, a second rebate and a second discount corresponding to one of the product and the further product.

9. The device of claim 1, further comprising:
an attachment arrangement detachably securing the device to a shelf.

10. The device of claim 1, wherein the device is an electronic price tag.

11. A system, comprising:
a wireless device situated adjacent a product and outputting first product-related data corresponding to the product; and
a server having access to second product-related data,
wherein, when the second-product related data is different from the first product-related data, the server transmits a signal including the second product-related data to the wireless device, and
wherein the wireless device outputs the second product-related data.

12. The system of claim 11, wherein the device includes a timer activating the device at a predetermined time period so that the device is powered during transmission of the second product-related data by the server.

13. The system of claim 11, wherein the first product-related data includes at least one of a first price, a first quantity, a first product identifier, a first coupon, a first rebate and a first discount corresponding to the product.

14. The system of claim 13, wherein the second product-related data includes at least one of a second price, a second quantity, a second product identifier, a second coupon, a second rebate and a second discount corresponding to one of the product and a further product.

15. The system of claim 11, wherein the device includes an attachment arrangement detachably securing the device to a shelf.

16. The system of claim 11, wherein the device is an electronic price tag.

17. A method for updating product-related data outputted by a wireless device, comprising:
situating the device adjacent a product;
initializing the device with first product-related data corresponding to the product;
outputting the first product-related data by the device;
receiving a wireless signal by the device, the signal including second product-related data, the second product-related data corresponding to one of the product and a further product;
replacing the first product-related data with the second product-related data in a memory of the device; and
outputting the second product-related data by the device.

18. The method of claim 17, wherein the replacing step includes the following substeps;
comparing the first product-related data to the second product-related data; and
replacing the first product-related data with the second product-related data only when the second product-related data is different from the first product-related data.

19. The method of claim 17, wherein the receiving step includes the following substeps:
powering a receiver of the device for a predetermined time period, the time period corresponding to transmission of the wireless signal.

20. A wireless device for outputting product-related data, comprising:
a storage means for storing first product-related data;
an output means for outputting the first product-related data;
a receiving means for receiving a wireless signal including second product-related data; and
a processing means,
wherein, when the receiving means receives the wireless signal, the processing means processes the second product-related data to replace the first product-related data so that the output means outputs the second product-related data,
wherein the device is situated adjacent to a product,
wherein, the first product-related data corresponds to the product and the second product-related data corresponds to one of the product and a further product.
